(19) United States
(12) Patent Application Publication
(10) Pub. No.: US 2009/0003171 A1
(43) Pub. Date: Jan. 1, 2009

(54) Method and Device for Reading Data

(76) Inventor: Johannes Leopoldus Bakx, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/280,369

(22) PCT Filed: Feb. 23, 2007
(86) PCT No.: PCT/IB07/50581

§ 371 Date: Aug. 22, 2008

(30) Foreign Application Priority Data
Feb. 24, 2006 (EP) 06110399.0

(51) Int. Cl. G11B 27/36

(52) U.S. Cl. 369/53.31; G9B/27.052

(57) ABSTRACT

The present invention relates to a method of reading data from a record carrier, the method comprising the steps of: obtaining a readout signal by radiating the record carrier in a first mode and a second mode of operation of a light source, computing a quality factor of the readout signal for the first mode and the second mode of operation of the light source, determining a best mode of operation of the light source based on the computed quality factors and selecting the determined best mode of operation of the light source for reading data from the record carrier. This is useful for high-speed Blu-ray disc applications.

The invention relates to a method of reading data from a record carrier.

The invention also relates to a device for reading data from a record carrier.

The invention also relates to a software program for reading data from a record carrier.

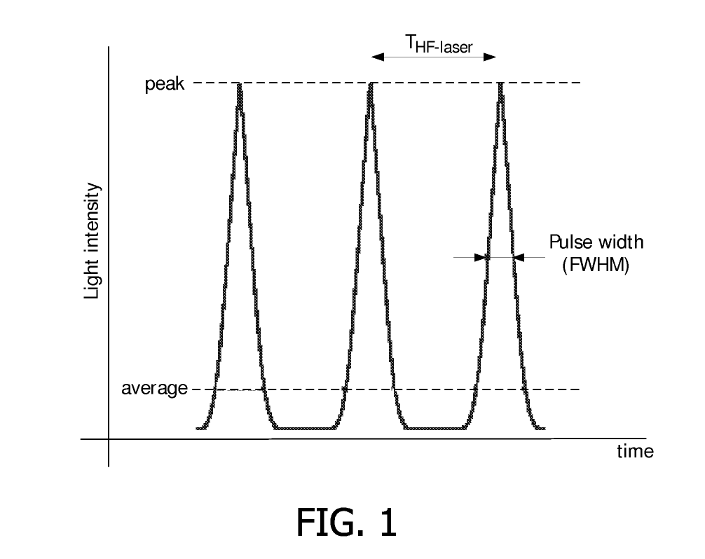

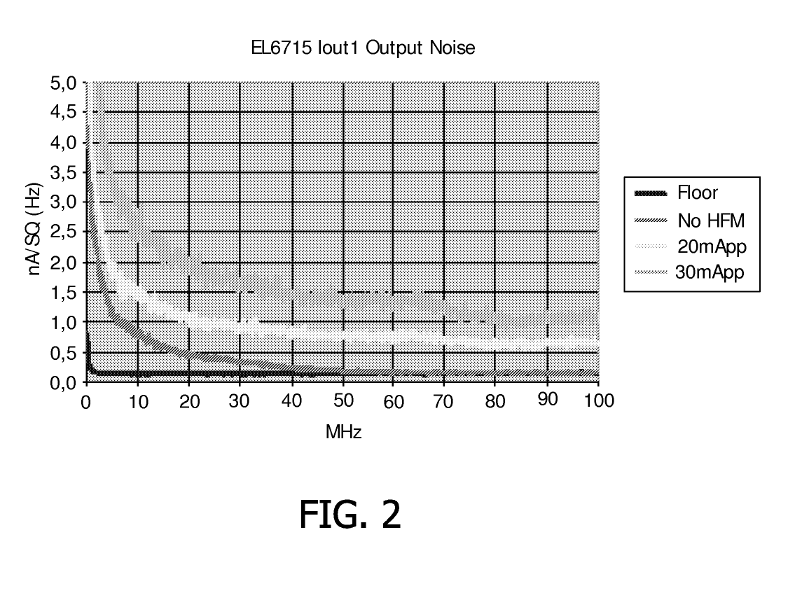

Data information is recorded on a record carrier, e.g. as a series of pits and lands representing binary data and forming a track. This information recorded on the record carrier, e.g. CD, DVD, Blu-ray disc is retrieved from a readout signal. A light/laser spot remains locked to the track for scanning. For optically scanning the rotating disc, an optical disc drive comprises a light beam generator, e.g. a laser diode, an objective lens for focusing the light/laser beam onto a spot on the disc and an optical detector for receiving the light reflected from the disc and for generating an electric detector signal. The reflected light spot is incident on the photodetector. The corresponding readout signal is derived from the photodetector. This readout signal takes a maximum/minimum value. The value taken by the readout signal depends on the amount of noise that reduces the level of the readout signal. During readout of an optical disc, the current supplied to the light/laser source is usually modulated with a sinusoid at a frequency of 200-500 MHz in order to suppress noise. This laser modulation method is used in CD-R/RW, DVD and Blu-ray players/recorders. An embodiment of an optical disc device is disclosed in JP63276720 wherein the laser current is modulated during reading of the optical disc. The modulation is applied in order to reduce the laser noise by varying a high-frequency superimposing current in accordance with the reproducing power of the optical disc. Thus, a modulation factor is optimized and the laser noise is reduced. There is a drawback of using laser modulation in a Blu-ray player/recorder as disclosed in JP63276720. The drawback of using laser modulation is illustrated in FIG. 1. FIG. 1 shows a plot of light output of a laser source when laser modulation is applied. The peaks of the light power are much larger than the average value, and in order to guarantee readout without degradation of the written data, the peaks should not exceed a certain limit. Therefore, the Blu-ray standard specifies that the maximum averaged readout power should not be larger than 0.3 mW in the case of laser modulation and not larger than 0.4 mW when no laser modulation is applied (1× speed). This power difference corresponds to a difference of 2.5 dB in favor of no modulation. The other drawback of applying laser modulation is that noise of the laser driver is larger when it has to generate a high frequency-modulated laser current. This further drawback of using laser modulation is illustrated in FIG. 2. FIG. 2 shows a plot of spectral density of the noise current in nA/√Hz of the output of a typical laser driver used in most optical pick-up units available on the market. In FIG. 2, the floor level is the noise level of the used spectrum analyzer (laser is switched off), No HFM is the noise level of the laser light when no laser modulation is applied, 20 mApp is the noise level of the laser light when the laser is modulated with a HF current of 20 mA peak-to-peak, and 30 mApp is the noise level of the laser light when the laser current is modulated with a HF current of 30 mA peak-to-peak. It can be observed from FIG. 2 that there is a large increase of noise when laser modulation is applied. It depends on other noise sources in the read channel how much overall decrease of signal-to-noise ratio this implies. Hence, if laser modulation is applied to suppress laser feedback noise at low readout powers, it does not have a significant effect on the signal-to-noise ratio of the readout signal. There are many factors that influence the amount of feedback noise in a laser, such as:

a) distance of laser to disc,
b) the amount of returning light in %,
c) the type of laser,
d) the used average laser power and the polarization properties of the light path.

It turns out that the feedback noise of Blue lasers in a Blu-ray disc player/recorder is low, which is mainly due to the very low percentage of light power that returns into the laser facet. At low readout powers, the amount of laser noise is less and hence the solution of using laser modulation does not always guarantee a positive effect on the signal-to-noise ratio of the readout signal, in particular for Blu-ray media.

It is therefore an object of the invention to provide a method of reading data from a record carrier that optimizes the signal-to-noise ratio of the readout signal.

It is a second object of the invention to provide a device for reading data from a record carrier that optimizes the signal-to-noise ratio of the readout signal.

It is a third object of the invention to provide a software program for reading data from a record carrier that optimizes the signal-to-noise ratio of the readout signal.

The first object of the invention is realized by providing a method of reading data from a record carrier, the method comprising the steps of:

obtaining a readout signal by radiating the record carrier in a first mode and a second mode of operation of a light source,

computing a quality factor of the readout signal for the first mode and the second mode of operation of the light source,

determining a best mode of operation of the light source based on the computed quality factors,

selecting the determined best mode of operation of the light source for reading data from the record carrier.

The first object of the invention is achieved by selecting a mode of operation of the light source that results in a higher signal-to-noise ratio of the readout signal, thereby improving the readout performance.

In an embodiment of the method, the first mode of operation of the light source comprises modulating the current supplied to the light source by switching on the light modulator, and the second mode of operation comprises not modulating the current supplied to the light source, i.e. switching off the light modulator during reading of the record carrier. Modulation is not applied if its application has a contrary effect, i.e. if it has the effect of decreasing the signal-to-noise ratio of the readout signal rather than increasing it. During readout, the two modes of operation, namely modulating the current supplied to the light source, i.e. modulator on, and not modulating the current supplied to the light source, i.e. modulator off, are compared. The effect of each mode of operation on the readout signal is compared for a particular record carrier at a particular speed. The mode that gives a higher level of signal-to-noise ratio of the readout signal is selected and used for reading data from the record carrier. This selection of the mode of operating the light source prevents the application of modulation without any justification.

In a further embodiment of the method, the method further comprises obtaining the readout signal during initialization, using maximum allowed read power for the first mode of operation of the light source, i.e. modulator on, and using maximum allowed read power for the second mode of operation of the light source, i.e. modulator off. It is advantageous to carry out the measurement at start-up, because afterwards the optical drive must read the user data under the best possible conditions. Hence, the measurement is done before any user data is read. By using a higher read power, the signal energy will be higher and the signal-to-noise ratio will consequently be higher.

In a still further embodiment of the method, the quality factor is computed on the basis of the jitter range of radial tilt. Very often, the optical drive measures this jitter range during start-up in order to find an optimum setting of the radial tilt actuator. The optical drive thus simply needs to measure each point twice, corresponding to the two read conditions, which hardly requires extra time. As the jitter curve is rather narrow in shape, the difference between the two conditions can be determined accurately.

In a still further embodiment of the method, the quality factor is computed on the basis of the jitter range of focus offset. Very often, the optical drive measures this jitter range during start-up in order to find an optimum setting of the focus actuator. The optical drive thus simply needs to measure each point twice, corresponding to the two read conditions, which hardly requires extra time. As the focus jitter curve is rather narrow in shape, the difference between the two conditions can be determined accurately.

In a still further embodiment, the method finds a mode of operation of the laser source that gives a wider quality factor window to determine the best mode of operation of the light source for reading data from the record carrier. The quality factor window is the jitter range of radial tilt or the jitter range of focus offset. The idea here is to use a variable that gives a pronounced jitter window when varying it along a suitable range. Selecting a wider quality factor, i.e. a wider jitter range makes the system more robust against e.g. tilted discs, bad media quality and misaligned optics.

In the methods of the embodiment, the record carrier is a Blu-ray disc, because the signal-to-noise ratio is very critical for Blu-ray disc readout and more so at higher speeds.

The second object of the invention is realized by providing a device for reading data from a record carrier, the device comprising:

readout means arranged to obtain a readout signal by radiating the record carrier in a first mode and a second mode of operation of a light source,

computing means arranged to compute a quality factor of the readout signal for the first mode and the second mode of operation of the light source,

determining means arranged to determine a best mode of operation of the light source based on the computed quality factors,

selecting means arranged to select the determined best mode of operation of the light source for reading data from the record carrier.

In an embodiment of the device, the device is a Blu-ray disc player/reader.

The third object of the invention is realized by providing a software program comprising an executable code for performing the method of reading data as described in the previous paragraphs.

These and other objects of the invention will be further elucidated and described, by way of example only, with reference to the accompanying drawings, in which:

FIG. 1 shows a plot of light output of a laser source when laser modulation is applied,

FIG. 2 shows a plot of spectral density of the noise current in nA/√Hz of the output of a typical laser driver,

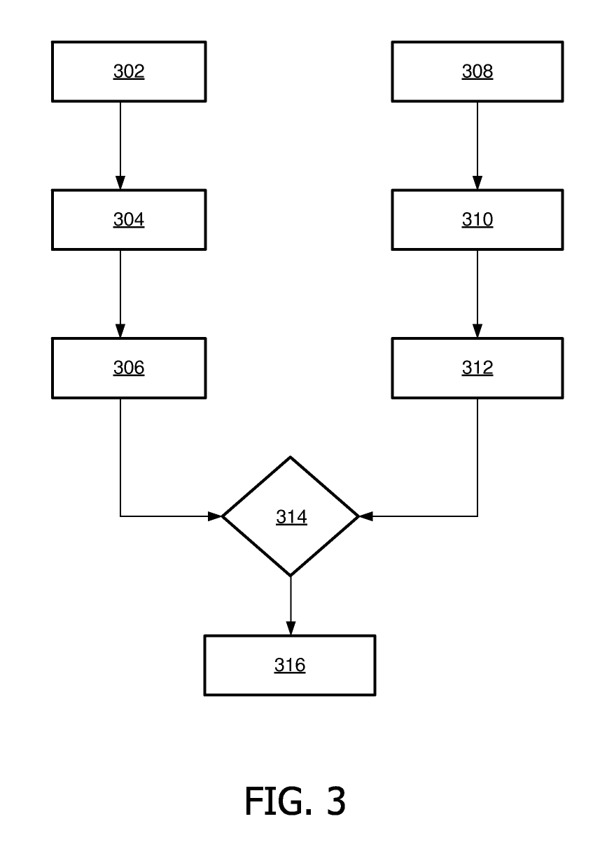

FIG. 3 is a flow chart of a method of reading data from a record carrier in accordance with an example of an embodiment of the invention,

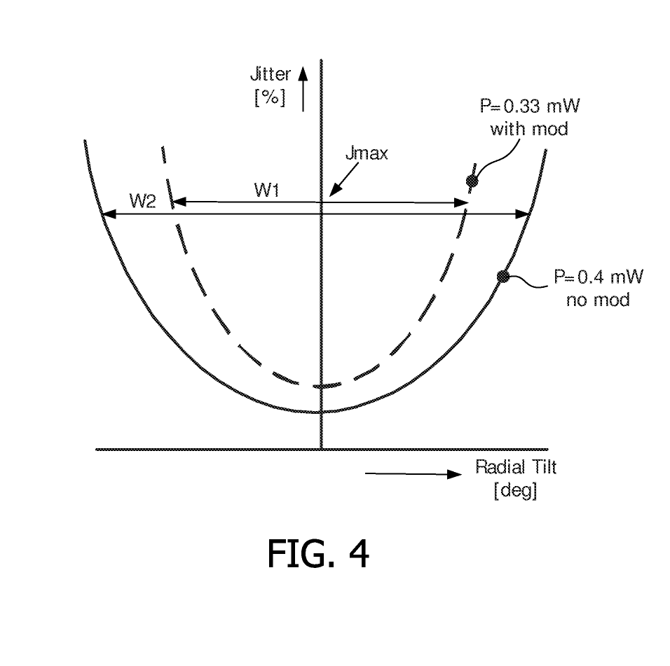

FIG. 4 shows details of a further embodiment for computing the quality factor based on the jitter range of radial tilt,

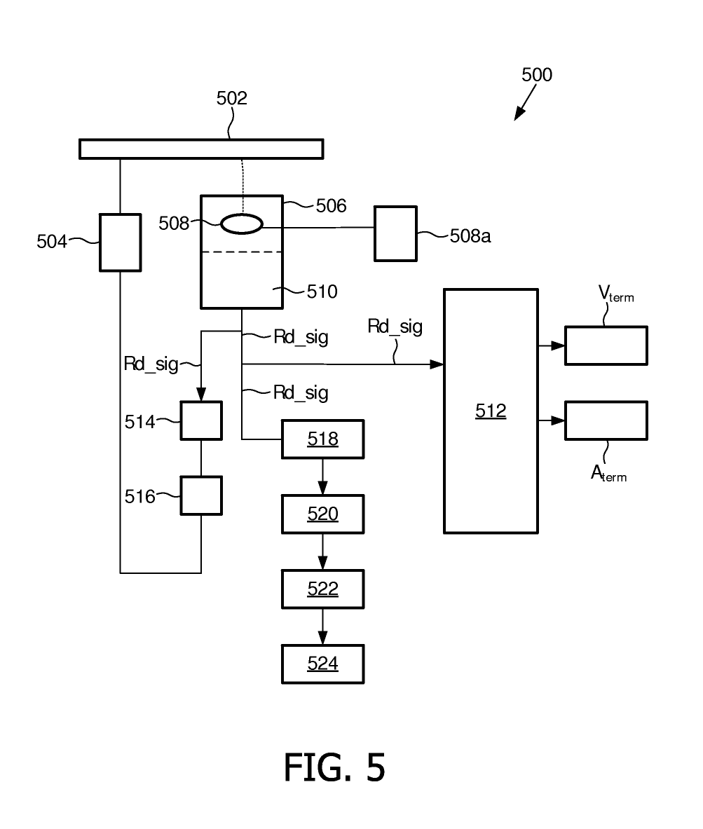

FIG. 5 is a block diagram that depicts one example of a player device, in particular a Blu-ray disc player to which the present invention is applied.

FIGS. 1 and 2 have been described in detail in the opening paragraph and will therefore not be described again.

FIG. 3 is a flow chart of a method of reading data from a record carrier in accordance with an example of an embodiment of the invention. For ensuring a robust reading of data stored on a record carrier, e.g. CD, DVD Blu-ray disc, it is required to generate a readout signal that has a good quality. Data recovery becomes difficult if the input readout signal has a low amplitude and is very noisy. Hence, a method of reading data from the record carrier, in particular a Blu-ray optical disc is proposed, wherein the readout signal has a higher signal-to-noise ratio, thereby improving the readout performance. In step 302, the light source, e.g. Blue laser is operated in a first mode of operation, wherein the current supplied to the light source, e.g. a Blue laser diode for reading data is modulated, i.e. the laser modulator is switched on. The laser modulator here refers to a high-frequency modulator to suppress laser feedback noise. For Blu-ray disc readout, the frequency of this modulator is typically 400 MHz, which is much higher than the frequency of the written data. In step 304, the readout signal Readout_{with mod} is obtained. In step 306, a quality factor QF_{with mod} is computed from the readout signal Readout_{with mod}. In step 308, the light source, e.g. Blue laser diode is operated in a second mode of operation, wherein the laser current supplied to the laser source, e.g. Blue laser diode for reading data is not modulated, i.e. the laser modulator is switched off. In step 310, the readout signal Readout_{no mod} is obtained. In step 312, a quality factor QF_{no mod} is computed from the readout signal Readout_{no mod}. In step 314, QF_{with mod} is compared with QF_{no mod} and a best mode of operating the light source is determined. In step 316, the determined best mode of operating the light source is selected for reading data from the record carrier.

In an embodiment of the method according to the invention, the readout signals Readout_{with mod} and Readout_{no mod} are measured at initial start-up of the optical drive. The measurement of the readout signal is done by using a maximum allowed read power for the first mode of operation of the light source, i.e. laser modulator on, and using a maximum allowed read power for the second mode of operation of the light source, i.e. laser modulator off, e.g. the Blu-ray disc standard specifies that readout power should be 0.3 mW with laser modulation and 0.4 mW without laser modulation. Hence, using the respective readout powers, the readout signal is obtained. Before attempting to read data from the record carrier, e.g. Blu-ray disc, the reading system must be initialized. This means that the value of certain system parameters must be initially determined so that the laser beam can be properly focused onto the spot and the tracks can be properly followed. It is advantageous to carry out the measurement at start-up, because afterwards the optical drive must read the user data under the best possible conditions. Hence, the measurement is done before any user data is read. By using a higher read power, the signal energy will be higher and consequently the signal-to-noise ratio will be higher.

In a still further embodiment of the method according to the present invention, the quality factor for each mode of operation of the light source, e.g. Blue laser diode is computed on the basis of the jitter range of radial tilt. Principally, a record carrier, e.g. a Blu-ray disc should be kept in a flat disc shape when it is set in a disc motor so that an optical pick-up unit can keep its optical axis perpendicular to the recording surface of the disc during reproducing operation. For scanning the recorded tracks, the optical pick-up unit moves in a radial direction in alignment with the radius of the disc. However, the disc set in the disc motor is not flat, mainly due to the manufacturing process. The disc curves in both radial and circumferential directions. Therefore, the optical pick-up unit cannot scan the recording tracks with its optical axis perpendicular to the recording surface of the disc. Furthermore, the angle varies in accordance with the position of the optical pick-up unit with respect to the disc. The angle formed between the optical axis and the recording surface in a radial direction is defined as radial tilt angle. Due to e.g. time errors in the high-frequency signal used for extracting data, a certain amount of jitter is always present when reading out an optical disc. The tilt angle between the disc and the objective lens is a result of two major contributors, namely the disc (contribution by manufacturing tolerances and environmental changes) and the drive (contribution by objective lens actuator, turntable motor adjustment, axis adjustment, disc speed, etc). The resulting angular deviations lead to a distortion of the optical readout spot on the disc. This distorted readout spot directly results in a distorted readout signal and thus in timing errors, i.e. jitter. Generally, the jitter increases at a greater rate as the radial tilt becomes larger. The computation of the quality factor based on the jitter range of radial tilt involves the following steps, and a possible result of this procedure is shown in FIG. 4.

1. Applying laser modulation by switching on the laser modulator and setting the read power at the maximum allowed value when using laser modulation, e.g. P=0.33 mW for a Blu-ray disc.

2. Dividing the range of radial tilt into N suitable points, e.g. N=15 points between −1 deg and +1 deg.

3. Measuring the jitter of a piece of data for each N tilt value. Using the same data for each tilt value.

4. Applying a suitable curve fitting (e.g. a parabola) on the found jitter values.

5. Calculating the width of the window W₁ of the jitter curve at some predefined limit value Jmax.

6. Switching off the laser modulation and setting the read power at the maximum allowed value when using no laser modulation, e.g. P=0.4 mW for a Blu-ray disc.

7. Repeating steps 3 to 5 and finding the width of the window W₂ of the jitter curve.

8. Determining which window is wider, W₁ or W₂.

9. Selecting the mode of operation of the laser source that gives the wider window to read the user data.

FIG. 4 shows that not applying laser modulation gives a wider window W₂ than applying laser modulation. This is not always the case. It is to be noted that this result may be different under different conditions, and that is why a measurement is done at start-up. Furthermore, selecting a wider window gives the advantage of having a system that is more robust against e.g. tilted discs, bad media quality and misaligned optics. In essence, the two modes of operation of the laser source, namely:

Mode 1: Low laser power and modulator on

Mode 2: High laser power and modulator off are compared. The mode that gives a wider margin is selected for reading data.

Very often, the optical drive measures this jitter range during start-up in order to find an optimum setting of the radial tilt actuator. The optical drive thus simply needs to measure each point twice, corresponding to the two read conditions, which hardly requires extra time. As the jitter curve is rather narrow in shape, the difference between the two conditions can be determined accurately. Although HD-DVD does not distinguish between modulated and non-modulated read power, the above procedure can still be used to find the best mode of operation for reading a HD-DVD.

In a still further embodiment of the method according to the invention, the quality factor for each mode of operation of the light source, e.g. a Blue laser diode is computed on the basis of the jitter range of focus offset. The procedure for computing the quality factor is similar as described for radial tilt in the previous paragraph. The optical drive can choose to use either radial tilt or focus offset or both or some other variable. The idea here is to use a variable that gives a pronounced jitter window when varying it along a suitable range.

FIG. 5 is a block diagram that depicts one example of a player device, in particular a Blu-ray disc player 500 to which the present invention can be applied. Referring to FIG. 5, a record carrier 502, e.g. a Blu-ray optical disc is rotationally driven by a spindle motor 504. An optical pick-up unit 506 radiates the Blu-ray disc with laser light emitted by the Blue laser light source 508, e.g. a Blue laser diode. The Blue laser light source 508 is operated in two different modes during reading of data from the Blu-ray disc 502. In a first mode of operation, the current supplied to the Blue laser source 508 is modulated, i.e. laser modulator 508a is switched on. The frequency of the laser modulator 508a is typically 400 MHz, which is much higher than the frequency of the written data. In a second mode of operation, the current supplied to the Blue laser source 508 is not modulated, i.e. laser modulator 508a is switched off. The optical pick-up unit 506 then receives light reflected on the Blu-ray disc 502 to generate a signal in accordance with the intensity of the received light. A photodetector 510 disposed within the optical pick-up unit 506, e.g. a photo diode receives the beam of light reflected on the Blu-ray disc 502 and then converts the light into electric signals, which in turn are output as read signals Rd_sig. The read signals Rd_sig are applied to a digital signal-processing unit (not shown) of the microcontroller 512. The digital signal-processing unit processes the received read signals and the processed signal is accordingly output to a video external output terminal Vₜₑᵣₘ and/or to an audio external output terminal Aₜₑᵣₘ. The optical pick-up unit 506 is also provided with a tracking actuator (not shown) and a focusing actuator (not shown). The tracking actuator changes the direction of an objective lens (not shown) to displace a read point of the laser beam spot in the radial direction of the Blu-ray disc 502. The focusing actuator controls the focus position of the aforementioned laser beam spot. In the above configuration, the optical pick-up unit 506 reads information recorded on the record carrier and outputs a read signal Rd_sig. A unit 514 extracts a tracking error signal and a focusing error signal from the read signal Rd_sig. The tracking error signal and the focusing error signal are supplied to a driver 516 which uses the tracking error signal and the focusing error signal to control the tracking actuator (not shown), the focusing actuator (not shown), the slide motor (not shown) and the spindle motor 504. The Blu-ray disc player 500 further comprises readout means 518 arranged to obtain the readout signal Rd_sig for a first mode of operation of the blue laser source 508, i.e. laser modulator 508a on, and a second mode of operation of the Blue laser source 508, i.e. laser modulator 508a off. The Blu-ray disc player 500 further comprises computing means 520 to compute a quality factor of the readout signal Rd_sig for the first mode of operation and the second mode of operation of the Blue laser source 508. The Blu-ray disc player 500 further comprises determining means 522 to determine a best mode of operation of the Blue laser source 508 based on the computed quality factors. The Blu-ray disc player further comprises means 524 arranged to select the determined best mode of operation of the Blue laser source 508 for reading data from the record carrier 502. The construction shown in FIG. 5 only illustrates portions related to the general operation of a Blu-ray player device. The description and detailed explanation of servocircuits for controlling the optical pick-up unit, the spindle motor, the slide motor, the digital signal-processing unit and the like are omitted, because they are constructed in a similar manner as in conventional systems.

In embodiments of the invention, the quality factor is computed on the basis of the jitter range of radial tilt or focus offset. Alternatively, the proposed method of the invention can be implemented by measuring with and without modulation, the bit error rate window or block error rate window of focus offset or radial tilt. Then the mode of operation of the light source that gives a wider window of bit error rate or block error rate can be selected for reading data from the record carrier.

In embodiments of the invention, the disclosed method of reading data from a record carrier may be implemented as a software program comprising an executable code to be executed by a device such as a Blu-ray player/reader for reading/playing data. When executed, the software program causes the device to perform the steps of the claimed methods for reading data from the Blu-ray disc by selecting the best mode of operating the laser source.

Although the invention has been mainly explained with reference to embodiments using optical discs, it is also suitable for other record carriers such as rectangular optical cards or any other type of information carrier that uses a light source and a light spot for reading data. A person skilled in the art can implement the described embodiments of the method of reading data from a record carrier in software or in both hardware and software. It will, however, be evident that various modifications and changes may be made without departing from the broader scope of the invention, as set forth in the appended claims. Use of the verb “comprise” and its conjugations does not exclude the presence of elements or steps other than those stated in a claim or in the description. Use of the indefinite article “a” or “an” preceding an element or step does not exclude the presence of a plurality of such elements or steps. The Figures and description are to be regarded for illustrative purposes only and may not be used to limit the invention.

In summary, the invention provides a method of reading data from a record carrier, the method comprising the steps of:

obtaining a readout signal by radiating the record carrier in a first mode and a second mode of operation of a light source,

computing a quality factor of the readout signal for the first mode and the second mode of operation of the light source,

determining a best mode of operation of the light source based on the computed quality factors,

selecting the determined best mode of operation of the light source for reading data from the record carrier.

This is useful for high-speed Blu-ray disc applications.

1. A method of reading data from a record carrier (502), the method comprising the steps of:
obtaining a readout signal by radiating the record carrier in a first mode and a second mode of operation of a light source,
computing a quality factor of the readout signal for the first mode and the second mode of operation of the light source,
determining a best mode of operation of the light source based on the computed quality factors,
selecting the determined best mode of operation of the light source for reading data from the record carrier.

2. The method as claimed in claim 1, wherein, in the first mode of operation of the light source, a light modulator (508a) supplying current to the light source (508) is switched on during reading of the record carrier and, in the second mode of operation of the light source, the light modulator (508a) supplying current to the light source (508) is switched off during reading of the record carrier.

3. The method as claimed in claim 2, the method further comprising obtaining the readout signal during initialization using maximum allowed read power for the first mode of operation and using maximum allowed read power for the second mode of operation of the light source.

4. The method as claimed in claim 1, wherein the quality factor is computed on the basis of the jitter range of radial tilt.

5. The method as claimed in claim 1, wherein the quality factor is computed on the basis of the jitter range of focus offset.

6. The method as claimed in claim 4, wherein the best mode of operation of the light source is a mode of operation that gives a wider quality factor window.

7. The method as claimed in claim 1, wherein the record carrier is a Blu-ray disc.

8. A device for reading data from a record carrier, the device comprising:
readout means (518) arranged to obtain a readout signal by radiating the record carrier in a first mode and a second mode of operation of a light source,
computing means (520) arranged to compute a quality factor of the readout signal for the first mode and the second mode of operation of the light source,
determining means (522) arranged to determine a best mode of operation of the light source based on the computed quality factors,
selecting means (524) arranged to select the determined best mode of operation of the light source for reading data from the record carrier.

9. The device as claimed in claim 8, wherein the device is a Blu-ray disc player/reader.

10. A software program comprising an executable code for performing all the steps of claim 1.
